(19) United States
(12) Patent Application Publication
(10) Pub. No.: US 2014/0156530 A1
(43) Pub. Date: Jun. 5, 2014

(54) Method and Device for Carrying Out Cashless Payments

(71) Applicant: Michael Suitner, Innsbruck (AT)

(72) Inventor: Michael Suitner, Innsbruck (AT)

(21) Appl. No.: 14/128,277

(22) PCT Filed: Jun. 19, 2012
(86) PCT No.: PCT/AT2012/000173

§ 371 Date: Dec. 20, 2013

(30) Foreign Application Priority Data
Jun. 22, 2011 (AT) A/912/2011

(51) Int. Cl. G06Q 20/32

(52) U.S. Cl. CPC G06Q 20/322
USPC 705/44

(57) ABSTRACT

A method for carrying out cashless payments by means of mobile telecommunications terminals, wherein each mobile telecommunications terminal stores a subscriber identifier and a payment limit, which is assigned to the subscriber identifier, a transaction code, which is specific to the payment transaction, includes generating them using an algorithm and transmitting the mobile telecommunications terminal. The telecommunications terminal transmits the subscriber identifier, the transaction code and the payment limit to a cash register system of a cashless payment transaction, where the transmitted payment limit is compared to the desired payment amount and the validity of the transaction code is checked using a verification algorithm stored in the cash register system. If the check is positive, the payment is released in the cash register system.

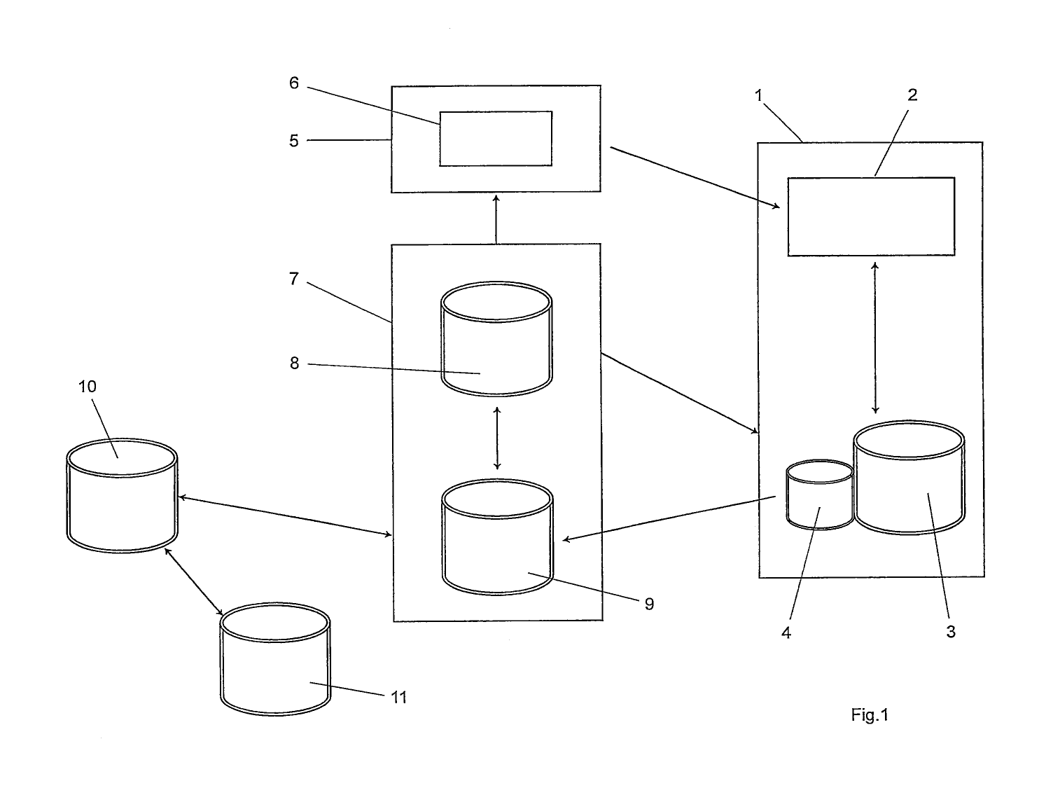

The invention relates to a method as well as to a device for carrying out cashless payments by means of mobile telecommunications terminals.

Typically, cashless payments are carried out via financial institutions and relate to payments in the form of book money between bank giro accounts, in the case of which no cash is moved. The account of the remitter is debited with the payment amount, the receiver receives a corresponding credit in his account. The financial institutions provide the service of making the transfer and, for the most part, receive a credit for fees, possibly in the context of flat fees for managing the account.

The order for carrying out a cashless payment can either be placed by the payment recipient or by the payer. In response to the placement of an order by the payer, the latter carries out a transfer, for example by means of electronic banking. For the most part, the placement of the order by the payment recipient is made by way of direct debiting based on a corresponding contractual relationship between payment recipient and payer. In addition to the classic transfer and the direct debiting, a plurality of electronic payment options exists, such as, for example, cash cards, debit cards and credit cards. On principle, the card payments use one of the above-mentioned basic payment methods. For the most part, the amounts are collected from the card owner via guaranteed non-refundable debits and his account is debited. In addition to the function of the cards as cashless payment means, they mainly serve to raise cash and, in the case of the credit card, to take advantage of short-term credit.

Even though the mentioned electronic payment options are associated with the advantage of a quick and easy payment as well as with high degree of safety due to the fact that only small amounts of cash are kept, there are a number of disadvantages. For example, the effort for the online authorization of the used card, which is required for the most part, in the course of the payment transaction is associated with a high degree of effort. The online authorization requires a direct data connection of the cash register system of the payment recipient to the computer center of the institution or of the bank, respectively, which issued the card. The online authorization delays the payment transaction and causes data transfer costs. The payment transaction is furthermore delayed even further by additional controls, such as entering a PIN, for example, so that user-friendliness as well as efficiency are low. In the case of the common payment methods, it is furthermore disadvantageous that a number of personal data of the payer are disclosed, so that there is a risk of misuse. In the case of common electronic payment options, the payment recipient knows the name of the card owner, his card number as well as the PIN code, for example. In the course of carrying out a transaction, further data are added, such as, for example, the purchased article as well as the account number of the payer. Together with the above-mentioned personal data, a clear assignability of different security-relevant and confidential data to individual persons is thus at hand, so that the risk of misuse of the data is high.

A common payment transaction using an electronic payment card typically runs as follows:
1) Amount is entered.
2) Card is demanded and is read by means of the card reader. The safety module is activated and demands the entering of the personal identification number.
3) The communication module establishes the connection to the provider and logs in at that location for the data exchange.
4) The plausibility checks are carried out via data exchange via the communication connection.
5) Via online connection to the bank, it is checked, whether a) no entry of the used card is present in the blacklist; b) the personal identification number, which was entered, is correct; c) the payment amount lies within the available budget. Payment is declined, if one of the conditions is not fulfilled.
6) The communication module logs off from the provider and terminates the connection. Some terminals are always online.
7) The printer establishes a protocol relating to payment or order, respectively. The display displays the corresponding information.
8) The result “payment made” guarantees the merchant that he will be paid.

The instant invention now aims at improving a method as well as a device of the above-mentioned type such that the effort for the authorization and the risk for a data misuse are reduced. The cashless payment is to be made possible in a simple manner by means of mobile telecommunications terminals, without having to accept losses with reference to the security of the payment transaction.

To solve this task, provision is made according to a first aspect of the invention for a method for carrying out cashless payments by means of mobile telecommunications terminals, wherein each telecommunications terminal stores a subscriber identifier and a payment limit, which is assigned to said subscriber identifier, comprising the steps:
generating a transaction code, which is specific to the payment transaction, using an algorithm,
transmitting the transaction code to the mobile telecommunications terminal,
transmitting the subscriber identifier, the transaction code and the payment limit from the mobile telecommunications terminal to a cash register system of the payment recipient in the context of a cashless payment transaction,
comparing the transmitted payment limit to the desired payment amount in the cash register system,
checking the validity of the transaction code in the cash register system using a verification algorithm stored in the cash register system,
releasing the payment in the cash register system, if the following conditions are fulfilled: the desired payment amount lies within the payment limit and the transaction code is valid,
storing the released payment in the cash register system for a later or immediate transfer to a payment processing center to initiate a debiting order.

In the context of the invention, the authorization of the payment thus takes place exclusively in the cash register system of the payment recipient, so that an online connection to a bank is no longer necessary. Due to the fact that the payer does not only transfer his subscriber identifier, but also the payment limit, which is assigned to the subscriber identifier, to the cash register system of the payment recipient in the context of the cashless payment transaction, the payment limit of the respective person is available to the payment recipient, without a further inquiry or control, respectively, is required concerning this matter at the institution or at the bank, respectively, which issued the card.

To authenticate the mobile telecommunications terminal of the payer, a transaction code is used, which is generated prior to carrying out the payment transaction and which was transmitted to the mobile telecommunications terminal of the payer. The transaction code is then subjected to a validity check in the cash register system of the payment recipient using a verification algorithm, which is stored in the cash register system, wherein the payment is authorized only if the validity check was positive. Only the verification algorithm stored in the cash register system is thus required to carry out the authentication of the payer, wherein the verification algorithm can also be renewed periodically so as to increase the security.

The payer is identified exclusively based on the subscriber identifier transmitted in the context of the payment transaction. Personal data are not available to the payment recipient in the context of the payment transaction, so that the highest possible data protection can be reached, namely in particular, if the subscriber identifier is neither the number of a credit, debit or cash card, nor the number of a bank account. If a relationship between the subscriber identifier and a telephone number of the mobile telecommunications terminal furthermore does not exist, an assignment to a certain person can also not be made in this way.

Due to the fact that, according to the invention, the authorization or release, respectively, of the payment takes place exclusively in the cash register system and due to the fact that an online connection to a bank or the like is thus not required for this, a plurality of payments can be collected in the cash register system, before the payments are passed on for actually carrying out the transfer or for initiating the direct debiting, respectively. In the alternative, however, it is also possible for the payments to be passed on immediately. In this context, a preferred procedure provides for the initiating of the debiting order to comprise the following steps:
transmitting a data set from the cash register system to a payment processing center, wherein the data set includes at least the subscriber identifier and the payment amount, and
transmitting the subscriber identifier from the payment processing center to a banking network in the context of a debiting order, wherein personal account numbers and subscriber identifiers are stored so as to be assigned to one another in the banking network or in an interface between the banking network and the payment processing center, and the subscriber identifier transmitted by the payment processing center is assigned to the corresponding account number and an account is debited using the account number.

It is significant hereby that, in terms of data protection, the payment processing center also does not have any personal data. The payment processing center only has data sets, which are provided by the cash register system and which include at least the subscriber identifier and the payment amount. On principle, the data set also includes further data, which provide for the payment transaction, such as, for example, an identification of the payment recipient and the like. The payment processing center subsequently transmits the data set to a banking network, either directly or indirectly, wherein the assignment of the subscriber identifier to an account number is made only at that location. This means that the assignment of the payment to a certain person can only be made at the bank. To further increase the security, provision is preferably made for the personal account number to be a virtual account number, wherein virtual account numbers and actual account numbers are stored within the banking network so as to be assigned to one another and the virtual account number is assigned to the corresponding actual account number in the context of a debiting order. The subscriber identifier is thus not translated directly into an actual account number of the payer, but a virtual account number is added in-between, so that the actual personal account number of the payer is also not available in the interface, which might be used, between the banking network and the payment processing center. Instead, the translation of the subscriber identifier into a virtual account number takes place in said interface, so that, even in the event that the payment processing center were to inadmissibly obtain access to the data sets of the interface, usable personal data cannot be acquired. A translation of the virtual account number into the actual account number takes place only after transmitting the payment data sets to the bank, so that an assignment of the payment to a specific person actually only becomes possible at the bank itself.

To prevent an unauthorized reading of the data, which are transferred between the mobile telecommunications terminal and the cash register system of the payment recipient, the approach is preferably such that the subscriber identifier, the transaction code and the payment limit are encoded in the mobile telecommunications terminal and are transmitted as code to the cash register system of the payment recipient, wherein the code is decoded in the cash register system.

The data transfer between the mobile telecommunications terminal and the cash register system can take place using common data transfer standards, for which the plurality of the telecommunications terminals is equipped. For example, modern mobile telephones have the option of a Bluetooth, WLAN or NFC connection. However, this requires a corresponding retrofitting of existing cash register systems, so as to attain the respective required hardware-related adaptation and to implement the respective transfer protocols with regard to software. To reduce the respective effort and to simultaneously realize a data transfer, which is as safe as possible and which does not require any additional equipment, provision is preferably made for the code to be an optoelectronically-readable code, in particular a bar code, which is displayed on a display unit of the mobile telecommunications terminal. Such an optoelectronically-readable code, in particular a bar code, can be read on the display unit of the telecommunications terminal by means of common and widespread barcode scanners. However, the system according to the invention can easily also be used by means of NFC technology.

In the context of the method according to the invention, checking the validity of the data provided by the payer is mainly based on the transmitted transaction code. The transaction code is hereby generated using an algorithm and is checked in the cash register system by means of a verification algorithm with regard to its validity. A particularly preferred embodiment results hereby when the verification algorithm and the algorithm, which is used for generating the transaction code, are compatible with one another. This means that the verification algorithm and the algorithm, which is used for generating the transaction code, must be mathematically linked with one another such that the verification algorithm only considers those transactions to be valid, which were generated using the algorithm, which was provided for generating the transaction code. To increase security, provision is hereby preferably made for the algorithm, which is used for generating the transaction code, to be stored in the payment processing center. The algorithm, which is used for generating the transaction code, thus lies outside of the sphere of influence of the payer, so that manipulation is made more difficult. Provision is preferably further made for the transaction code to be generated in the payment processing center.

As already mentioned, the payer provides the respective payment limit in response to each payment transaction, so that the effort for the corresponding verification on the part of the payment recipient is dispensed with. In the simplest case, the payer can determine the payment limit himself, which can be made by setting a corresponding standard value in the mobile telecommunications terminal, for example. However, setting the payment limit can also be carried out separately for each payment. Setting the payment limit by the payer, however, has the disadvantage that the corresponding account coverage is not guaranteed. Provision is thus preferably made for the payment limits to be managed centrally. Provision is hereby preferably made for the subscriber identifiers to, be stored in the payment processing center and for a respective payment limit to be assigned to each subscriber identifier, and for the payment processing center to transmit the payment limit to the mobile telecommunications terminal. It is particularly preferred, when the payment limit, which is assigned to a subscriber identifier in the payment processing center, is reconciled with a stored payment limit, which is assigned to the respective subscriber identifier in a banking network.

To ensure that the current payment limit is available in each case for a payment transaction, the approach in the context of the invention can be such that a payment limit, which was changed after a reconciliation, is transmitted to the mobile telecommunications terminal, which corresponds to the subscriber identifier, together with a new transaction code.

To further increase the security, provision is preferably made for the mobile telecommunications terminal to additionally transmit a time stamp to the cash register system, preferably in encoded form, in the context of the cashless payment transaction, and for the time stamp to be compared to the current time in the cash register system and for the payment to be released in the cash register system, if the difference between the current time and the time stamp does not exceed a defined value.

The functions required for carrying out the cashless payment transaction are designed such that they can easily be realized on common mobile telephones. A particularly comfortable and user-friendly embodiment hereby provides for the method steps, which can be executed on the mobile telecommunications terminal, to be implemented in a program application, which can be downloaded to the device. Such a program application can provide for a corresponding user-friendly and appealing user surface at the same time. The function of encoding the data, which are to be transmitted, can also be implemented in the program application, wherein a corresponding large-surface display element also provides for the display of a bar code, which is preferably provided. The subscriber identifier can furthermore be embedded in the program application in a simple manner, wherein provision is preferably made in this context for the subscriber identifier to be an application-specific identifier, which is generated by the banking network, for example, and which is stored in the program application. To increase security, provision can preferably furthermore be made for the application to start a PIN query prior to transmitting the subscriber identifier, the transaction code, the payment limit and the time stamp, if applicable, from the mobile telecommunications terminal to the cash register system, and for the transmission to only take place if the PIN was entered correctly. In detail, the sequence can be provided for as follows, for example:
a) The application receives subscriber identifier, transaction codes and payment limit at a time, at which the mobile telephone is online—possibly long before the application is activated for payment.
b) When the PIN is entered in the application, it is preferably checked once again, whether the code, which is already held ready in the application, still includes the correct payment limit, that is, a reconciliation with the payment limit stored in the payment processing center is carried out.
c) If the payment limit is out-dated, it is replaced by a new payment limit.
d) If an online connection is not available at the time the PIN is entered, the payment limit, which is held ready, is used.

According to a second aspect of the invention, a device for carrying out cashless payments by means of mobile telecommunications terminals is proposed, comprising an electronic payment processing center and at least one electronic cash register system of a payment recipient, wherein the payment processing center encompasses at least one database, which stores subscriber identifiers of mobile telecommunications terminals and payment limits assigned to the subscriber identifiers, a transaction code generator, which generates a transaction code, which is specific to the respective payment transaction using an algorithm, and transfer means for transferring the transaction code and the assigned payment limit to the mobile telecommunications terminal, and wherein the cash register system is embodied to receive and to check data transmitted by a mobile telecommunications terminal in the context of a cashless payment transaction, namely the subscriber identifier, the transaction code and the payment limit, wherein the cash register system encompasses input means for entering a payment amount, wherein the cash register system further encompasses processing means, which are embodied to compare the transmitted payment limit to the desired payment amount and to check the validity of the transaction code using a verification algorithm stored in the cash register system, wherein the cash register system further encompasses release means for releasing the payment, if the following conditions are fulfilled: the desired payment amount lies within the payment limit and the transaction code is valid, wherein the cash register system further encompasses a storage for storing the released payment, wherein the storage cooperates with a transfer means to pass the payment to the payment processing center either later or immediately for initiating a debiting order. Preferred further developments of the devices according to the invention are defined in the subclaims.

The invention will be explained in more detail below by means of an exemplary embodiment, which is illustrated schematically in the drawing. 1 identifies a cash register system of a payment recipient, which comprises at least one cash register 2, which is connected to a central cash register server 3. The cash register server 3 can hereby be located locally on the location of the cash register 2. In particular in the case of cash register systems comprising a plurality of spatially distributed cash registers 2, the cash register server 3 can also be arranged at a remote location. The cash register server 3 is a common accounting system, to which data relating to the payments processed by the individual cash registers 2 are transmitted. Typically, the payment amount, an identification of the cash register 2 as well as the time of payment is thereby transmitted for each payment. The cash registers are thereby suitable to process cash payments as well as electronic cashless payments. The connection of the individual cash registers 2 to the cash register server 3 takes place via common protocols, such as via an XML web service, for example.

In the exemplary embodiment at hand, the common cash register server 3 is supplemented with a program add-on 4, which allows for the implementation of the instant invention.

A mobile telecommunications terminal of a user is identified with 5. This is a common mobile telephone, wherein smart phones are suitable in particular. A program application 6, which allows for the processing of the cashless payment method according to the invention, is installed on the mobile telecommunications terminal 5.

The central processing center is identified with 7 and comprises a payment server 8 as well as a database 9. The payment processing center 7 can establish a data connection to the cash register system 1 as well as to the mobile telecommunications terminal 5.

The payment processing center 7 is furthermore connected to an exchange server 10, which, in turn, is in contact with a bank 11 or corresponding electronic banking networks.

From the point of view of a customer, who wants to process a cashless payment, the processing of a cashless payment according to the instant invention runs as follows. It is assumed hereby that the customer has an account at a bank. Initially, the bank customer must load the program application 6 to his mobile telecommunications terminal 5. Preferably, this takes place such that the bank customer signs into the online banking area of his bank and links the program application 6 to his bank account at that location. As soon as the customer has loaded the program application 6 to his mobile telecommunications terminal 5 and has it installed thereon, the end device 5 is ready for cashless payment transactions. Prior to this, a subscriber identifier generated by the bank 11 was stored in the program application 6. The storing process can either take place by means of manually entering the subscriber identifier by the customer or can already have been stored by the bank in the program application, which is provided for downloading. It is significant that the subscriber identifier is a clear and unique identifier, so that it is thus possible to clearly identify the subscriber based on the subscriber identifier.

In the event that the customer wants to pay without cash in a store, he opens the program application 6 on his mobile telecommunications terminal 5. The program application displays a unique barcode, which is read by a barcode reader of the cash register 2, on the display unit of the mobile telecommunications terminal 5. The code transmitted in this manner is checked for validity in the cash register system 1. If the quality verification was positive, the barcode is accepted as payment and the payment amount is consequently withdrawn from the customer's bank account.

To provide for the above-described cashless payment transaction, the technical implementation is provided as follows. The bank 11 is connected to the payment processing center 7 via the exchange server 10. When a bank customer downloads the program application 6, the bank 11 notifies the payment processing center 7 accordingly. The bank 11 hereby initially transmits the subscriber identifier assigned to the bank customer, together with an anonymous virtual account number, to the exchange server 10. The virtual account number is not the actual account number of the bank giro account, which the subscriber keeps with the bank 11. The subscriber identifier and the virtual account number, which is in each case assigned to the subscriber identifier, are stored in the exchange server 10. The payment processing center 7 subsequently receives only the subscriber identifier. As a result, the payment processing center 7 does not have any actual account numbers of the bank customer, so that, on principle, the data, which are available in the payment processing center 7, are anonymous, which has the result that the security standard in the payment processing center 7 as well as in the cash register system 1 can be chosen so as to be lower and that a possible data theft does not render any usable or personal data, respectively. The further data exchange between the payment processing center 7 and the bank 11 takes place only via the virtual account number, that is, by mediation of the exchange server 10.

The bank 11 sends the payment limit, which is assigned to the respective account, to the payment processing center 7 together with the subscriber identifier. Provided that the payment limit of a customer changes subsequently, the bank 11 can send a new payment limit to the payment processing center 7 via the interface server 10 at any time.

The payment processing center 7 stores the subscriber identifier and the respective assigned payment limit in the database 9. These data are transmitted to the payment server 8, which comprises a transaction code generator, by means of which clear transaction codes, which can be used once, can be generated using an algorithm, which is stored in the payment server 8. To prepare a cashless payment transaction by means of the mobile telecommunications terminal 5, the payment server 8 generates a code, which includes the subscriber identifier, the payment limit and the automatically generated transaction code, preferably in encrypted form, and transmits this code to the program application 6 of the mobile telecommunications terminal 5. The data transfer can either take place upon inquiry from the program application 6 or can be initiated by the payment server 8. It is significant hereby that the data is transmitted only if it was first determined that the program application 6 includes the subscriber identifier, which corresponds to the subscriber identifier included in the code, which is to be transmitted.

In the program application 6, a time stamp is added to the code received by the payment server 8. From the subscriber identifier, the payment limit, the transaction code and the time stamp, the program application 6 subsequently generates a barcode, which is displayed on the display unit of the mobile telecommunications terminal 5. The cash register 2 scans the displayed barcode by means of a barcode scanner and transmits it to the cash register server 3. The program add-on 4 implemented in the cash register server 3 decodes the transmitted code and can check, whether the transmitted transaction code is valid, by means of a locally stored verification algorithm. In addition, it is determined by means of the transmitted time stamp, whether the transmitted code is still valid. It is furthermore checked, whether the desired payment amount, which the cash register 2 transmitted to the cash register system 3 together with the code, conforms to the payment limit, which was also transmitted. The cash register system is connected to the payment server 8, whereby the verification algorithm stored in the cash register system 3 can be changed at any time.

Provided that the verification of the code, which was transmitted to the cash register system 3, showed that the code is valid, the cash register system 3 notifies the cash register 2 that the payment can be accepted.

Provided that the payment was released, the cash register system 3 transmits the accepted code, which includes the subscriber identifier, the payment limit, the transaction code and the time stamp as well as additionally the payment amount and further payment-relevant data, such as an identification of the cash register and of the merchant, for example, to the payment processing center 7 and in particular to the database 9. After these data are received in the database 9, the generation of a new transaction code is released by the payment sever 8 and the transmission thereof to the program application 6 of the respective customer is released, so that a new cashless payment transaction can be initiated. The payment processing center 7 furthermore transmits a data set, which includes the subscriber identifier, the payment amount and an identification of the merchant and, if applicable, also the time stamp, an invoice number and further payment-relevant data, to the exchange server 10. The exchange server 10 can assign the subscriber identifier to a virtual account number and sends a debiting order as well as the transaction details to the bank 11 or to a corresponding banking network, respectively, together with the virtual account number. At that bank 11, the actual account of the customer is assigned by means of the virtual account number and the corresponding payment amount is debited to the account.

1. A method for carrying out cashless payments by means of mobile telecommunications terminals, wherein each telecommunications terminal stores a subscriber identifier and a payment limit, which is assigned to said subscriber identifier, comprising the steps:
generating a transaction code, which is specific to the payment transaction, using an algorithm,
transmitting the transaction code to the mobile telecommunications terminal,
transmitting the subscriber identifier, the transaction code and the payment limit from the mobile telecommunications terminal to a cash register system of the payment recipient in the context of a cashless payment transaction,
comparing the transmitted payment limit to the desired payment amount in the cash register system,
checking the validity of the transaction code in the cash register system using a verification algorithm stored in the cash register system,
releasing the payment in the cash register system, if the following conditions are fulfilled: the desired payment amount lies within the payment limit and the transaction code is valid,
storing the released payment in the cash register system for a later or immediate transfer to a payment processing center to initiate a debiting order, wherein the subscriber identifiers are stored in the payment processing center and a respective payment limit is assigned to each subscriber identifier, and the payment processing center transmits the payment limit to the mobile telecommunications terminal, wherein the payment limit, which is assigned to a subscriber identifier in the payment processing center, is reconciled with a stored payment limit, which is assigned to the respective subscriber identifier in a banking network, wherein a payment limit, which was changed after a reconciliation is transmitted to the mobile telecommunications terminal, which corresponds to the subscriber identifier, together with a new transaction code.

2. The method according to claim 1, wherein the initiating of the debiting order comprises the following steps:
transmitting a data set from the cash register system to the payment processing center, wherein the data set includes at least the subscriber identifier and the payment amount, and
transmitting the subscriber identifier from the payment processing center to a banking network in the context of a debiting order, wherein personal account numbers and subscriber identifiers are stored so as to be assigned to one another in the banking network or in an interface between the banking network and the payment processing center, and the subscriber identifier transmitted by the payment processing center is assigned to the corresponding account number and a debiting from an account is made using the account number.

3. The method according to claim 2, wherein the personal account number is a virtual account number, wherein virtual account numbers and actual account numbers are stored within the banking network so as to be assigned to one another and the virtual account number is assigned to the corresponding actual account number in the context of a debiting order.

4. The method according to claim 1, wherein the subscriber identifier, the transaction code and the payment limit are encoded in the mobile telecommunications terminal and are transmitted as code to the cash register system of the payment recipient, wherein the code is decoded in the cash register system.

5. The method according to claim 4, wherein the code is an optoelectronically-readable code, in particular a bar code, which is displayed on a display unit of the mobile telecommunications terminal.

6. The method according to claim 1, wherein the verification algorithm and the algorithm, which is used for generating the transaction code, are compatible with one another.

7. The method according to claim 1, wherein the algorithm, which is used for generating the transaction code, is stored in the payment processing center.

8. The method according to one of claim 1, wherein the verification algorithm is generated in the payment processing center and is transmitted to the cash register system.

9. The method according to claim 1, the transaction code is generated in the payment processing center.

10. The method according to claim 1, wherein the subscriber identifier is a device-specific identifier.

11. The method according to claim 1, wherein the mobile telecommunications terminal additionally transmits a time stamp to the cash register system, preferably in encoded form, in the context of the cashless payment transaction, and the time stamp is compared to the current time in the cash register system and the payment is released in the cash register system, if the difference between the current time and the time stamp does not exceed a defined value.

12. The method according to claim 1, wherein the method steps, which can be executed on the mobile telecommunications terminal, are implemented in a program application, which can be loaded to the device.

13. The method according to claim 12, wherein the subscriber identifier is an application-specific identifier, which is generated by the banking network and which is stored in the program application.

14. The method according to claim 12, wherein the application starts a PIN query prior to transmitting the subscriber identifier, the transaction code, the payment limit and the time stamp, if applicable, from the mobile telecommunications terminal to the cash register system, and the transmission only takes place if the PIN was entered correctly.

15. A device for carrying out cashless payments by means of mobile telecommunications terminals, in particular for carrying out a method according to claim 1, comprising an electronic payment processing center and at least one electronic cash register system of a payment recipient, wherein the payment processing center encompasses at least one database which stores subscriber identifiers of mobile telecommunications terminals and payment limits assigned to the subscriber identifiers, a transaction code generator, which generates a transaction code, which is specific to the respective payment transaction using an algorithm, and transfer means for transferring the transaction code and the assigned payment limit to the mobile telecommunications terminal and wherein the cash register system is embodied to receive and to check data transmitted by a mobile telecommunications terminal in the context of a cashless payment transaction, namely the subscriber identifier, the transaction code and the payment limit, wherein the cash register system encompasses input means for entering a payment amount, wherein the cash register system further encompasses processing means, which are embodied to compare the transmitted payment limit to the desired payment amount and to check the validity of the transaction code using a verification algorithm stored in the cash register system, wherein the cash register system further encompasses release means for releasing the payment, if the following conditions are fulfilled: the desired payment amount lies within the payment limit and the transaction code is valid, wherein the cash register system further encompasses a storage for storing the released payment, wherein the storage cooperates with a transfer means to pass the payment to the payment processing center either later or immediately for initiating a debiting order, wherein the payment processing center comprises reconciliation means, which cooperate with the banking network, to reconcile the payment limit, which is assigned to a subscriber identifier in the payment processing center with a stored payment limit, which is assigned to the respective subscriber identifier in a banking network, and wherein the reconciliation means are embodied with a trigger circuit to trigger the transmission of a payment limit, which was changed after a reconciliation process, to the mobile telecommunications terminal, which corresponds to the subscriber identifier, together with a new transaction code.

16. The device according to claim 15, wherein the transfer means of the cash register system is embodied to transfer a data set to the payment processing center, wherein the data set includes at least the subscriber identifier and the payment amount, and that the payment processing center is connected to a banking network, wherein the payment processing center is embodied to transmit the subscriber identifier to the banking network in the context of a debiting order.

17. The device according to claim 16, wherein personal account numbers and subscriber identifiers are stored so as to be assigned to one another in the banking network or in an interface between the banking network and the payment processing center, and the banking network is embodied to assign the subscriber identifier transmitted by the payment processing center to the corresponding account number and to debit an account using the account number.

18. The device according to claim 17, wherein the personal account number is a virtual account number, wherein virtual account numbers and actual account numbers are stored within the banking network so as to be assigned to one another and the virtual account number can be assigned to the corresponding actual account number in the context of a debiting order.

19. The device according to claim 15, wherein provision is made for encoding means for encoding the subscriber identifier, the transaction code and the payment limit and to transmit them to the cash register system of the payment recipient as code, and that the cash register system comprises decoding means for decoding the transmitted code.

20. The device according to claim 19, wherein the code is an optoelectronically-readable code, in particular a bar code, which is displayed on a display unit of a mobile telecommunications terminal.

21. The device according to claim 15, wherein the verification algorithm and the algorithm, which is used for generating the transaction code, are compatible with one another.

22. The device according to claim 15, wherein the payment processing center comprises a storage for the algorithm, which is used to generate the transaction code.

23. The device according to claim 15, wherein the subscriber identifier is a device-specific identifier.

24. The device according to claim 15, wherein provision is made for a clock module, which is suitable to additionally transmit a time stamp to the cash register system, preferably in encoded form, in the context of the cashless payment transaction, and for the cash register system to encompass a clock module and for the processing means of the cash register system to be embodied to compare the time stamp to the current time provided by the clock module of the cash register system, wherein the release means are embodied to release the payment, if the difference between the current time and the time stamp does not exceed a defined value.

25. The device according to claim 15, wherein provision is made for a program application, which can be executed on the mobile telecommunications terminal.

26. The device according to claim 25, wherein the subscriber identifier is an application-specific identifier, which is stored in the program application.

27. The device according to claim 25, wherein the application comprises a PIN query for querying a PIN prior to transmitting the subscriber identifier, the transaction code, the payment limit and the time stamp, if applicable, to the cash register system, wherein the transmission only takes place if the PIN was entered correctly.

28. The device according to claim 17, wherein the reconciliation means are embodied with a trigger circuit to trigger the transmission of a payment limit, which was changed after a reconciliation process, to the mobile telecommunications terminal, which corresponds to the subscriber identifier, together with a new transaction code.

29. The device according to claim 18, wherein provision is made for a clock module, which is suitable to additionally transmit a time stamp to the cash register system, preferably in encoded form, in the context of the cashless payment transaction, and for the cash register system to encompass a clock module and for the processing means of the cash register system to be embodied to compare the time stamp to the current time provided by the clock module of the cash register system, wherein the release means are embodied to release the payment, if the difference between the current time and the time stamp does not exceed a defined value.

30. The device according to claim 18, wherein provision is made for a program application, which can be executed on the mobile telecommunications terminal.

31. The device according to claim 30, wherein the subscriber identifier is an application-specific identifier, which is stored in the program application.

32. The device according to claim 30, wherein the application comprises a PIN query for querying a PIN prior to transmitting the subscriber identifier, the transaction code, the payment limit and the time stamp, if applicable, to the cash register system, wherein the transmission only takes place if the PIN was entered correctly.
